(19) United States
(12) Patent Application Publication
(10) Pub. No.: US 2026/0213934 A1
(43) Pub. Date: Jul. 23, 2026

(54) ACCESS CONTROL METHOD BASED ON OUTSOURCED COMPUTATION AND ATTRIBUTE-BASED SEARCHABLE ENCRYPTION ON BLOCKCHAIN

(71) Applicant: Hubei University, Wuhan (CN)

(72) Inventors: Peng HE, Wuhan (CN); Shuai HU, Wuhan (CN); Yifan WANG, Wuhan (CN); Yin YUAN, Wuhan (CN); Qiaoxian ZHENG, Wuhan (CN); Hui CHEN, Wuhan (CN)

(73) Assignee: Hubei University, Wuhan, HB (CN)

(21) Appl. No.: 19/466,272

(22) Filed: Jan. 30, 2026

(30) Foreign Application Priority Data
Feb. 18, 2025 (CN) 2025101781251

(51) Int. Cl. H04L 9/08; H04L 9/00; H04L 9/32

(52) U.S. Cl. CPC H04L 9/0866; H04L 9/0825; H04L 9/3271; H04L 9/50

(57) ABSTRACT

The present disclosure pertains to the field of data sharing and particularly discloses an access control method based on outsourced computation and attribute-based searchable encryption on blockchain. The method comprises steps of generating a system public key and a master key, and generating a user attribute private key; formulating an access control policy to assist an outsourced encryption service provider in performing a partial encryption using a data ciphertext storage address and a symmetric key, and uploading a blockchain; generating a search trapdoor and sending the search trapdoor to the blockchain to verify the user attribute; and partially decrypting the ciphertext with assistance of the outsourced decryption service, followed by local decryption to obtain a data storage address and the symmetric key. The present disclosure alleviates the computational burden of local encryption and decryption for users, and leads to a significant improvement in data sharing efficiency and security.

### TECHNICAL FIELD

The present disclosure pertains to the field of cyberspace security data sharing, particularly an access control method based on outsourced computing on the blockchain and attribute-based searchable encryption.

### BACKGROUND

With the rapid advancement of cloud computing, data has emerged as the most critical resource in the network era. Given this context, cross-domain data exchange and sharing have gained increasing importance, and the role of access control mechanisms has shown a correspondingly greater prominence. The primary objective of access control is to safeguard the security of data resources, ensuring that confidentiality, integrity, and availability of resources are effectively maintained under diverse security requirements. By implementing appropriate access control policies, access control restricts the access rights of subjects (e.g., users) to resources, thereby guaranteeing that only legitimate users can access and manipulate relevant data. While existing access control mechanisms can effectively manage and control access rights within a single administrative domain to ensure data security, the secure exchange of cross-domain data has become particularly crucial with the rapid growth in data sharing demands and the increasing cooperation and business interactions among enterprises and organizations.

Outsourced encryption and decryption refers to a technology that transfers encryption and decryption operations from conventional local systems or devices to third parties (e.g., cloud service providers). In data processing, it enables users to outsource these computationally intensive encryption and decryption operations to cloud services, thereby reducing the consumption of local computing resources and enhancing the efficiency and flexibility of the system. In outsourced encryption, the user outsources the encryption operation to a cloud service provider or another third party. In this process, encryption occurs on the data prior to storage or transmission, thereby ensuring that the data remains unreadable and protected from tampering even if accessed by external entities. In outsourced decryption, based on the outsourced encryption, outsourced decryption further allows a third party to decrypt the encrypted data, subject to the satisfaction of predetermined conditions. Through effective encryption and decryption control and authority management, it can be ensured that only qualified users or services are permitted to decrypt data, and the decryption operation can be performed by a third party.

Blockchain is a distributed ledger that connects multiple data blocks in chronological order, forming a chain-like structure, featuring decentralization, immutability, collective maintenance, full traceability, and transaction traceability. The encryption algorithms are utilized to ensure data security, transparency, and immutability. When sharing data across multiple institutions or enterprises, blockchain provides a trusted and neutral platform, avoiding the trust issues inherent in conventional data sharing. Through the consensus mechanism, blockchain guarantees data consistency and coordination among all participating parties.

Attribute-based searchable encryption is a cryptographic technology that integrates attribute-based encryption (ABE) with searchable encryption (SE). During the encryption process, data is not only bound to access control policies (e.g., limiting decryption to users with certain attributes), but also enables data to be encrypted and queried based on keywords or attributes. In a search operation, the query request is matched against the attributes of the encrypted data. Only users satisfying the access control policy can execute such a search, and the actual data content remains concealed throughout the process, thereby enabling secure queries on specific attributes within the encrypted dataset. With growing demands in cloud computing, data sharing, and privacy preservation, this technology is attracting increasing attention, particularly in scenarios requiring fine-grained access control and efficient data retrieval.

### SUMMARY

Aiming at the limitations of existing attribute-based encryption, such as substantial local computational burden and low data-sharing efficiency, the present disclosure provides an access control method based on outsourced computation and attribute-based searchable encryption on a blockchain. This method can improve the efficiency and security of data sharing and reduce the computational burden on local users.

In order to achieve the above objective, the present disclosure provides an access control method based on outsourced computation and attribute-based searchable encryption on a blockchain, the method includes the following steps:
S1, utilizing an attribute authority (AA) to initialize and generate a system public key (PK) and a master key (MSK), and generate a user attribute private key (SK) based on an attribute set of a data user (DU);
S2, formulating an access control policy by a data owner (DO) to assist an outsourced encryption service provider in performing a partial encryption, with the DU and the outsourced encryption service provider encrypting keywords, a data ciphertext storage address, and a symmetric key, and uploading the encrypted ciphertext to a blockchain for storage;
S3, generating a search trapdoor by the DU, sending the search trapdoor to the blockchain, calling a search trapdoor contract to verify the user attribute, and returning the relevant keyword-corresponding ciphertext to the DU if the user attributes satisfy the access control policy; and
S4, partially decrypting the ciphertext with an assistance of the outsourced decryption service provider by the DU, followed by local decryption to obtain a data storage address and a symmetric key, downloading the data ciphertext from an InterPlanetary File System (IPFS) accordingly, and finally decrypting the data ciphertext utilizing the symmetric key to obtain data plaintext.

In S1, the specific steps of utilizing the AA to initialize and generate the system PK and the MSK are as follows:
utilizing the AA to execute an initialization algorithm Setup(1^{λ})→(PK, MSK) and input a security parameter λ, thereby generating a multiplicative cyclic group G₁ and G_{T} of a prime order p, with a given bilinear mapping pair e: G₁×G₁→G_{T}, defining two random anti-collision Hash functions. For each attribute i∈U, randomly selecting parameters t₁, t₂, and t₃, and calculating e(g,g)^{α} and g^{β} respectively, thereby generating the system PK and the MSK:

$$P K = \{ {g}^{{t}_{1}} , {g}^{{t}_{2}} , {g}^{{t}_{3}} , {g}^{β} , {e ( g , g )}^{α} , {H}_{1} , {H}_{2} \} ;$$

$$MSK = \{ {t}_{1} , {t}_{2} , {t}_{3} , α , β \} ;$$

where e(g,g)^{α} and g^{β} are mathematical formulas of a double mapping pair in cryptography, and they are all calculation results, which belong to a component of the system PK, g is a generator of G₁, a mapping relationship

$${H}_{1} : {\{ 0 , 1 \}}^{*} \to {G}_{`} , {H}_{2} : {\{ 0 , 1 \}}^{*} \to {Z}_{p}^{*} , {Z}_{p}^{*}$$

denotes s finite field of 1, 2, . . . , p-1, {0,1}* denotes a set of bit strings of arbitrary length, U is a set of system attributes, and two integers α, and β∈E Z*ₚ of the finite field are randomly selected.

In S1, the specific steps of utilizing the AA to generate the user attribute SK based on the attribute set of the data used are as follows:
S11, utilizing the AA to execute a key generation algorithm KeyGenblind(PK,MSK,S)→(SK), inputting the system PK and the MSK and a user attribute set S, blinding each attribute i with the AA utilizing a Schnorr protocol, where i∈S, calculating Q, and L, calculating a challenge a, and calculating a response of (pt to the challenge σᵢ, calculation formulas are as follows:

$$Q = z \cdot G ;$$

$$L = m \cdot G ;$$

$${σ}_{i} = {H}_{2} ( G \vert Q \vert P \vert j ) ;$$

$${φ}_{i} = m + {σ}_{i} * z ( mod p ) ;$$

where Q denotes a blinded public key, L denotes a computational value of a binding of a signature and a message content, σᵢ a denotes a randomly generated challenge sent by a verifier to a prover, φᵢ denotes a response generated by a prover based on the prover's secret and the challenge, and sent to a verifier, G is a point on a elliptic curve, and the DU randomly selects two integers z,

$$m ∈ {Z}_{p}^{*}$$

in the finite field;
S12, with info={P,Q, φᵢ, σᵢ}, sending info to an intelligent contract by the DU, wherein for each attribute i∈U, the AA generates the attribute SK based on the blinded user attribute set, randomly selecting an integer

$$u ∈ {Z}_{p}^{*}$$

within the finite field, and calculating the attribute SK:

$$S K = \{ {D}_{1} = {g}^{\frac{( {t}_{1} {t}_{3} - u )}{{t}_{2}}} , {D}_{2} = {g}^{\frac{( α + u )}{β}} , {\{ {D}_{i} = {g}^{u} \cdot {{H}_{1} ( i )}^{{φ}_{i}} , {D}_{i}^{′} = {g}^{{φ}_{i}} \}}_{i ∈ S} ;$$

where info is a defined quadruple, and D₁ and D₂ are partial composition parameters of the attribute SK.

Preferably, in S2, the specific steps of the DU and the outsourced encryption service provider encrypt the keywords, the data ciphertext storage address and the symmetric key, and upload the encrypted ciphertext to the blockchain for storage are as follows:
S21, performing a partial encryption by the encryption service provider (ESP) to form an intermediate ciphertext; and
S22, on the basis of the intermediate ciphertext, performing a sequence by the DO of first encrypting the data plaintext, then encrypting the data ciphertext storage address, and finally encrypting a keyword set and a symmetric key.

Preferably, in S21, the specific steps of performing the partial encryption by the ESP to form the intermediate ciphertext are as follows:
S211, executing an EncryptESP(PK,T) algorithm by the ESP, inputting the access control policy formulated by the user and converting it into an access structure tree T;
S212, utilizing the system PK starting from the root node of the access structure tree T, randomly selecting a polynomial qₓ of order dₓ for each non-leaf node x of the access structure tree from top to bottom, randomly selecting a positive integer

$$s ∈ {Z}_{p}^{*}$$

in the finite field as a node value of a root node R in the access structure tree T, setting qR(0)=s, and letting Y be an attribute set of the leaf nodes in access structure tree T; then calculating and outputting the intermediate ciphertext as: CT_{ESP}={Dₓ, D′ₓ}, where

$${h}_{x} = {H}_{1} ( a t t ( x ) ) ; {D}_{x} = {g}^{{q}_{x} ( 0 )} ; {D}_{x}^{′} = {h}_{x}^{{q}_{x} ( 0 )} ;$$

where hx denotes a result of a Hash function H₁, an input att(x) is an attribute of the leaf node, Dₓ is a power term of a generator of the group G₁,

$${D}_{x}^{′}$$

is a power term result of the Hash function H₁, qₓ(0) is a value of the polynomial qₓ corresponding to the leaf node at 0 point, dₓ=kₓ−1, kₓ denotes a threshold of the node, and for other non-leaf nodes x, setting qₓ(0)=qparent(x)(index(x)), x∈Y.

Preferably, in 522, the specific steps of performing the sequence by the DO of first encrypting the data plaintext, then encrypting the data ciphertext storage address, and finally encrypting the keyword set and the symmetric key are as follows:
S221, extracting the keyword setW in the data plaintext m by the DO, encrypting the data plaintext m by utilizing the symmetric key, generating a data ciphertext=Enc(m,key) and uploading it to the IPFS, and encrypting the returned data ciphertext storage address with the same symmetric key key to generate a storage address ciphertext CT_{addr}=Enc(addr,key);

S222, defining a keyword set W={ω} and the symmetric key by the DO, and performing attribute-based encryption by executing an encryption algorithm Encrypt_{DO}(PK, CT_{ESP}, key, W)→CT, then randomly selecting a user attribute set

$$S ∈ {Z}_{p}^{*}$$

by the DO, calculating C₀=key·e(g,g)^{αs} and C₁=g^{βs}, and outputting the obtained symmetric key ciphertext as CT_{key}={C₀,C₁};
where C₀ and C₁ both denote symmetric key partial ciphertexts, jointly forming the symmetric key ciphertext, C₀ is related to the symmetric key, and C₁ is related to the attribute set S;

S223, randomly selecting a positive integer field

$$n ∈ {Z}_{p}^{*} ,$$

calculating keyword ciphertext

$$C {T}_{ω} = \{ {C}_{2} = {g}^{{t}_{1} ( n + s )} \cdot {g}^{{t}_{2} n {H}_{2} ( ω )} , {C}_{3} = {g}^{{st}_{2}} \} ,$$

storage address ciphertext CT_{addr}=Enc(addr, key), and final ciphertext CT=(CT_{key}, CT_{ω}, CT_{addr}, CT_{ESP}), and uploading them to the blockchain for storage, wherein in the blockchain, an index generation contract is used to create an index for the keyword ciphertext, where C₂ and C₃ both denote partial ciphertexts of the keyword ciphertext.

Preferably, in S3, the specific steps of the DU generates the search trapdoor and calls the intelligent contract in the blockchain to perform keyword matching and obtain the ciphertext are as follows:
S31, executing a Trapdoor generation algorithm Trapdoor(PK,SK,S,τ)→T_{τ} by the DU, inputting the system PK, the attribute SK, the attribute set S of the DU and a search keyword τ, randomly selecting an element

$$v ∈ {Z}_{p}^{*}$$

by the DU, calculating search trapdoor parameters

$${y}_{1} = {g}^{{t}_{1} v} \cdot {g}^{{t}_{2} v {H}_{2} ( τ )} , {y}_{2} = {g}^{{t}_{3} v} , {y}_{3} = {D}_{1}^{v} ,$$

generating a search trapdoor

$${T}_{τ} = \{ {y}_{1} , {y}_{2} , {y}_{3} , {\{ {B}_{i} = {( {D}_{i} )}^{v} , {B}_{i}^{′} = {( {D}_{i}^{′} )}^{v} \}}_{i ∈ S} \} ,$$

and sending it to the blockchain for a search verification;
S32, when calling the intelligent contract in the blockchain, firstly verifying a legality of the DU attribute, and when the verification is successful, searching the ciphertext corresponding to the matching keyword, a calculation formula of the intelligent contract is L′=φᵢ G−σᵢ Q;
S33, performing a determination: if L′=L, the attribute verification is successful, returning and sending the relevant ciphertext set to the DU, and the DU sends it to the outsourced decryption service provider, if the attribute verification fails, terminating the entire algorithm process.

Preferably, a search trapdoor intelligent contract in the blockchain is utilized to verify whether the DU attribute set satisfies the access control policy, and the attribute legitimacy is verified by a non-interactive Schnorr protocol.

Preferably, in S4, the specific steps of partially decrypting the ciphertext with the assistance of the outsourced decryption service provider by the DU are as follows:
S411, returning a decryption result to the DU, adopting an execution algorithm Decrypt_{DSP}(PK, CT_{ESP}, T_{τ},S)→F_{Δ}, and dividing the process into two scenarios:
S4111, x(x∈S) is a leaf node, then a calculated value Fₓ of the leaf node x used for decryption is:

$${F}_{x} = \frac{e ( {B}_{i} , {D}_{x} )}{e ( {B}_{i}^{′} , {D}_{x}^{′} )} = {e ( g , g )}^{u v {q}_{x} ( 0 )} ;$$

where, when x∉S, Fₓ=⊥;
S4112, x are non-leaf nodes, assuming that ρₓ is a set of child nodes with an arbitrary threshold, then for each child node π of the non-leaf nodes x, calculating a value F, obtained from a weighted cumulative computation over each non-leaf node x within the set ρₓ used for decryption as:

$${F}_{π} = {\prod }_{π ∈ {ρ}_{x}} {F}_{π}^{{Δ}_{j , {ρ}_{x}^{′}} ( 0 )} {ρ}_{x}^{′} = \{ index ( π ) : π ∈ {ρ}_{x} \} , j = index ( π ) = {\prod }_{π ∈ {ρ}_{x}} {( {e ( g , g )}^{u v {q}_{π} ( 0 )} )}^{{Δ}_{j , {ρ}_{x}^{′}} ( 0 )} = {\prod }_{π ∈ {ρ}_{x}} {( {e ( g , g )}^{u v {q}_{x} ( j )} )}^{{Δ}_{j , {ρ}_{x}^{′}} ( 0 )} = {e ( g , g )}^{u v {q}_{x} ( 0 )} ;$$

S412, determining whether the attribute set of DU satisfies the access control policy, if the access control policy is satisfied, performing a partial decryption to obtain converted ciphertext F_{Δ}=e(g,g)^{uvs} and returning it to the DU.

Preferably, in S4, the specific steps of obtaining the symmetric key after DU acquires the converted ciphertext and performs local decryption, followed by accessing IPFS to perform final decryption and obtain the plaintext data are as follows:
S421, utilizing an execution algorithm Decrypt_{DSP}(PK, CT, F_{Δ},SK,S)→m to decrypt the DU, calculating a result by the following formula:

$$θ = \frac{e ( {C}_{1} , {C}_{2} )}{{F}_{Δ}^{\frac{1}{v}}} = \frac{e ( {g}^{β s} , {g}^{\frac{( α + u )}{β}} )}{{e ( g , g )}^{us}} = {e ( g , g )}^{α s} ;$$

where θ denotes a partial decryption result of the symmetric key ciphertext, and the partial decryption result is used to decrypt the data ciphertext key;
S422, solving the data ciphertext key

$$key = \frac{{C}_{0}}{θ} = \frac{key \cdot {e ( g , g )}^{α s}}{{e ( g , g )}^{α s}} = key$$

by the DU, decrypting the data ciphertext storage address ddr=Dec(key, CT_{addr}), accessing the IPFS from addr to obtain data ciphertext CTₘ, and finally decrypting the data ciphertext to obtain data plaintext m=Dec(key, CTₘ).

Therefore, the present disclosure provides an access control method based on outsourced computation and attribute-based searchable encryption on a blockchain, which has the following beneficial effects:
the present disclosure addresses the limitations of existing attribute-based encryption, such as substantial local computational burden and low data-sharing efficiency, which can improve the efficiency and security of data sharing and reduce the computational burden on local users. Consequently, it effectively alleviates the computational burden of local encryption and decryption for users, and leads to a significant improvement in data sharing efficiency and security.

Further detailed descriptions of the technical scheme of the present disclosure can be found in the accompanying drawings and embodiments.

### BRIEF DESCRIPTION OF THE DRAWINGS

FIG. 1 is a diagram of an access control model based on outsourced computation and attribute-based searchable encryption on a blockchain of the present disclosure.

### DETAILED DESCRIPTION OF THE EMBODIMENTS

In order to make the objectives, the technical solutions, and the advantages of the present disclosure clearer, the following clearly and completely describes the technical solutions in embodiments of the present disclosure. Apparently, the described embodiments are only some but not all of the embodiments of the present disclosure. All other embodiments obtained by those of ordinary skill in the art based on the embodiments of the present disclosure without involving any creative effort shall fall within the scope of protection of the present disclosure.

Unless otherwise defined, technical or scientific terms used in the present disclosure are to be given their ordinary meaning as understood by those of ordinary skill in the art to which the present disclosure belongs.

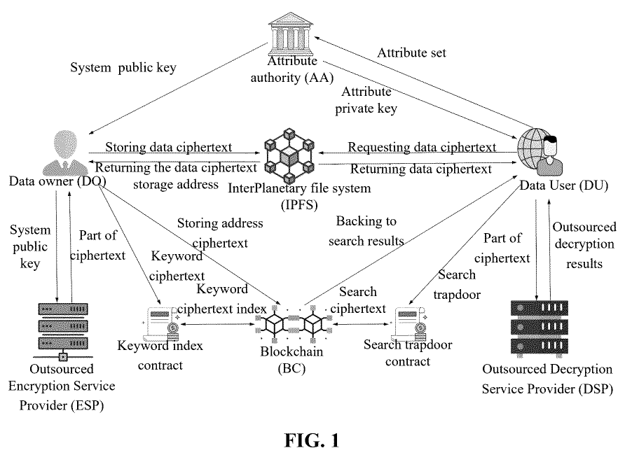

As shown in FIG. 1, the present disclosure provides the access control method based on outsourced computation and attribute-based searchable encryption on blockchain, the method includes the following steps:
S1, the AA is utilized to initialize and generate the system PK and the MSK, and generate the user attribute SK based on the attribute set of the data user.
In S1, the specific steps of utilizing the AA to initialize and generate the system PK and the MSK are as follows:
the AA is utilized to execute the initialization algorithm Setup(1^{λ})→(PK, MSK) and input the security parameter λ, thereby generating the multiplicative cyclic group G₁ and G_{T} of the prime order p, with the given bilinear mapping pair e: G₁×G₁→G_{T}, two random anti-collision Hash functions are defined. For each attribute i∈U, parameters t₁, t₂, and t₃ are randomly selected, and e(g,g)^{α} and g^{β} are calculated, respectively, thereby generating the system PK and the MSK:

$$P K = \{ {g}^{{t}_{1}} , {g}^{{t}_{2}} , {g}^{{t}_{3}} , {g}^{β} , {e ( g , g )}^{α} , {H}_{1} , {H}_{2} \} ;$$

$$MSK = \{ {t}_{1} , {t}_{2} , {t}_{3} , α , β \} ;$$

where e(g,g)^{α} and g^{β} are mathematical formulas of the double mapping pair in cryptography, and they are all calculation results, which belong to the component of the system PK, g is the generator of G₁, the mapping relationship

$${H}_{1} : {\{ 0 , 1 \}}^{*} \to {G}_{1} , {H}_{2} : {\{ 0 , 1 \}}^{*} \to {Z}_{p}^{*} , {Z}_{p}^{*}$$

denotes s finite field of 1, 2, . . . , p-1, {0,1}* denotes the set of bit strings of arbitrary length, U is the set of system attributes, and two integers α, and

$$β ∈ {Z}_{p}^{*}$$

of the finite field are randomly selected.

In S1, the specific steps of utilizing the AA to generate the user attribute SK based on the attribute set of the data used are as follows:
S11, the AA is utilized to execute the key generation algorithm KeyGenblind(PK,MSK,S)→(SK), the system PK and the MSK and the user attribute set S are input, each attribute i is blinded with the AA utilizing the Schnorr protocol, where i∈S, Q, and L are calculated, the challenge σᵢ is calculated, and the response of φ₁ to the challenge σᵢ is calculated, the calculation formulas are as follows:

$$Q = z \cdot G ;$$

$$L = m \cdot G ;$$

$${σ}_{i} = {H}_{2} ( G \vert Q \vert P \vert j ) ;$$

$${ϕ}_{i} = m + {σ}_{i}^{*} z ( mod p ) ;$$

where Q denotes the blinded public key, L denotes the computational value of the binding of the signature and the message content, σᵢ denotes the randomly generated challenge sent by the verifier to the prover, φᵢ denotes the response generated by the prover based on the prover's secret and the challenge, and sent to the verifier, G is the point on the elliptic curve, and the DU randomly selects two integers z,

$$m ∈ {Z}_{p}^{*}$$

in the finite field;
S12, with info {P,Q, φᵢ, σᵢ}, info is sent to the intelligent contract by the DU, wherein for each attribute i∈U, the AA generates the attribute SK based on the blinded user attribute set, the integer

$$u ∈ {Z}_{p}^{*}$$

within the finite field is randomly selected, and the attribute SK is calculated as follows:

$$S K = \{ {D}_{1} = {g}^{\frac{( {t}_{1} {t}_{3} - u )}{{t}_{2}}} , {D}_{2} = {g}^{\frac{( α + u )}{β}} , {\{ {D}_{i} = {g}^{u} \cdot {{H}_{1} ( i )}^{{φ}_{i}} , {D}_{i}^{′} = {g}^{{φ}_{i}} \}}_{i ∈ S} ;$$

where info is the defined quadruple, and D₁ and D₂ are partial composition parameters of the attribute SK.

S2, the access control policy is formulated by the DO to assist the outsourced encryption service provider in performing the partial encryption, with the DU and the outsourced encryption service provider encrypting keywords, the data ciphertext storage address, and the symmetric key, and the encrypted ciphertext is uploaded to the blockchain for storage. The specific steps are as follows:
S21, the partial encryption is performed by the ESP to form the intermediate ciphertext; and
S22, on the basis of the intermediate ciphertext, the sequence is performed by the DO of first encrypting the data plaintext, then encrypting the data ciphertext storage address, and finally encrypting the keyword set and the symmetric key.

In S21, the specific steps of performing the partial encryption by the ESP to form the intermediate ciphertext are as follows:
S211, the EncryptESP(PK,T) algorithm is executed by the ESP, the access control policy formulated by the user is input and converted into the access structure tree T;
S212, the system PK is utilized starting from the root node of the access structure tree T, the polynomial qₓ of order dₓ is randomly selected for each non-leaf node x of the access structure tree from top to bottom, the positive integer

$$s ∈ {Z}_{p}^{*}$$

in the finite field is randomly selected as the node value of the root node R in the access structure tree T, qR(0)=s is set, and let Y be the attribute set of the leaf nodes in the access structure tree T; then the intermediate ciphertext is calculated and output as:

$${CT}_{ESP} = \{ {D}_{x} , {D}_{x}^{′} \} , where$$

$${h}_{x} = {H}_{1} ( a t t ( x ) ) ; {D}_{x} = {g}^{{q}_{x} ( 0 )} ; {D}_{x}^{′} = {h}_{x}^{{q}_{x} ( 0 )} ;$$

where hx denotes the result of the Hash function H₁, the input att(x) is the attribute of the leaf node, Dₓ is the power term of the generator of the group G₁, D′ₓ is the power term result of the Hash function H₁, qₓ(0) is the value of the polynomial qₓ corresponding to the leaf node at 0 point, dₓ=kₓ-1, kₓ denotes the threshold of the node, and for other non-leaf nodes x, setting qₓ(0)=qparent(x)(index(x)), x∈Y.

In S22, the specific steps of performing the sequence by the DO of first encrypting the data plaintext, then encrypting the data ciphertext storage address, and finally encrypting the keyword set and the symmetric key are as follows:
S221, the keyword set W in the data plaintext m is extracted by the DO, the data plaintext m is encrypted by utilizing the symmetric key, the data ciphertext=Enc(m,key) is generated and uploaded to the IPFS, and the returned data ciphertext storage address with the same symmetric key key is encrypted to generate the storage address ciphertext CT_{addr}=Enc(addr,key);
S222, the keyword set W={ω} and the symmetric key are defined by the DO, and the attribute-based encryption is performed by executing the encryption algorithm Encrypt_{DO}(PK, CT_{ESP}, key, W)→CT, then the user attribute set

$$S ∈ {Z}_{p}^{*}$$

is randomly selected by the DO, C₀=key·e(g,g)^{as} and

$${C}_{1} = {g}^{β s}$$

are calculated, and the obtained symmetric key ciphertext is output as CT_{key}={C₀,C₁};
where C₀ and C₁ both denote symmetric key partial ciphertext, jointly forming the symmetric key ciphertext, C₀ is related to the symmetric key key, and C₁ is related to the attribute set S;
S223, the positive integer field

$$n ∈ {Z}_{p}^{*}$$

is randomly selected, the keyword ciphertext

$${CT}_{ω} = \{ {C}_{2} = {g}^{{t}_{1} ( n + s )} \cdot {g}^{{t}_{2} {nH}_{2} ( ω )} , {C}_{3} = {g}^{{st}_{2}} \} ,$$

storage address ciphertext CT_{addr}=Enc(addr,key), and final ciphertext CT=(CT_{key},CT_{ω},CT_{addr},CT_{ESP}) are calculated, and uploaded to the blockchain for storage, wherein in the blockchain, the index generation contract is used to create the index for the keyword ciphertext, where C₂ and C₃ both denote partial ciphertexts of the keyword ciphertext.

S3, the search trapdoor is generated by the DU, the search trapdoor is sent to the blockchain, the search trapdoor contract is called to verify the user attribute, and the relevant keyword-corresponding ciphertext is returned to the DU if the user attributes satisfy the access control policy.

In S3, the specific steps of the DU generates the search trapdoor and calls the intelligent contract in the blockchain to perform keyword matching and obtain the ciphertext are as follows:
S31, the Trapdoor generation algorithm Trapdoor(PK,SK,S,τ)→T_{τ} is executed by the DU, the system PK, the attribute SK the attribute set S of the DU and the search keyword τ are input, the element

$$v ∈ {Z}_{p}^{*}$$

is randomly selected by the DU, the search trapdoor parameters

$${y}_{1} = {g}^{{t}_{1} v} \cdot {g}^{{t}_{2} {vH}_{2} ( τ )} , {y}_{2} = {g}^{{t}_{3} v} , {y}_{3} = {D}_{1}^{v}$$

are calculated, the search trapdoor

$${T}_{τ} = \{ {y}_{1} , {y}_{2} , {y}_{3} , {\{ {B}_{i} = {( {D}_{i} )}^{v} , {B}_{i}^{′} = {( {D}_{i}^{′} )}^{v} \}}_{i ∈ S} \}$$

is generated, and sent to the blockchain for the search verification;
S32, when calling the intelligent contract in the blockchain, the legality of the DU attribute is first verified, in which the search trapdoor intelligent contract in the blockchain is utilized to verify whether the DU attribute set satisfies the access control policy, and the attribute legitimacy is verified by the non-interactive Schnorr protocol. When the verification is successful, searching the ciphertext corresponding to the matching keyword, the calculation formula of the intelligent contract is L′=φᵢG−σᵢ Q;
S33, the determination is performed: if L′=L, the attribute verification is successful, returning and the relevant ciphertext set is sent to the DU, and the DU sends it to the outsourced decryption service provider, if the attribute verification fails, the entire algorithm process is terminated.

S4, the ciphertext is partially decrypted with the assistance of the outsourced decryption service provider by the DU, followed by local decryption to obtain the data storage address and the symmetric key, the data ciphertext is downloaded from the IPFS accordingly, and finally, the data ciphertext is decrypted utilizing the symmetric key to obtain the data plaintext.

In S4, the specific steps of partially decrypting the ciphertext with the assistance of the outsourced decryption service provider by the DU are as follows:
S411, the decryption result is returned to the DU, the execution algorithm Decrypt_{DSP}(PK, CT_{ESP}, T_{τ}, S)→F_{Δ} is adopted, and the process is divided into two scenarios:
S4111, x(x∈S) is the leaf node, then the calculated value Fₓ of the leaf node x used for decryption is:

$${F}_{x} = \frac{e ( {B}_{i} , {D}_{x} )}{e ( {B}_{i}^{′} , {D}_{x}^{′} )} = {e ( g , g )}^{{uvq}_{x} ( 0 )} ;$$

where, when x∉S, Fₓ=∀;
S4112, x are non-leaf nodes, assuming that ρₓ is the set of child nodes with an arbitrary threshold, then for each child node π of the non-leaf nodes x, the value F, obtained from the weighted cumulative computation over each non-leaf node x within the set ρₓ used for decryption is calculated as:

$${F}_{π} = {\prod }_{π ∈ {ρ}_{x}} {F}_{π}^{{Δ}_{j , {ρ}_{x}^{′}} ( 0 )} {ρ}_{x}^{′} = \{ index ( π ) \text{:} π ∈ {ρ}_{x} \} , j = index ( π ) = {\prod }_{π ∈ {ρ}_{x}} {( {e ( g , g )}^{{uvq}_{π} ( 0 )} )}^{{Δ}_{j , {ρ}_{x}^{′}} ( 0 )} = {\prod }_{π ∈ {ρ}_{x}} {( {e ( g , g )}^{{uvq}_{x} ( j )} )}^{{Δ}_{j , {ρ}_{x}^{′}} ( 0 )} = {e ( g , g )}^{{uvq}_{x} ( 0 )} ;$$

S412, whether the attribute set of DU satisfies the access control policy is determined, if the access control policy is satisfied, the partial decryption is performed to obtain converted ciphertext F_{Δ}=e(g,g)^{uvs} and returned to the DU.

In S4, the specific steps of obtaining the symmetric key after DU acquires the converted ciphertext and performs local decryption, followed by accessing IPFS to perform final decryption and obtain the plaintext data are as follows:
S421, the execution algorithm Decrypt_{DSP} (PK, CT, FA, SK, S)→m is utilized to decrypt the DU, the result is calculated by the following formula:

$$θ = \frac{e ( {C}_{1} , {D}_{2} )}{{F}_{Δ}^{\frac{1}{v}}} = \frac{e ( {g}^{β s} , {g}^{\frac{( α + u )}{β}} )}{{e ( g , g )}^{us}} = {e ( g , g )}^{α s} ;$$

where θ denotes the partial decryption result of the symmetric key ciphertext, and the partial decryption result is used to decrypt the data ciphertext key;
S422, the data ciphertext key

$$key = \frac{{C}_{0}}{θ} = \frac{key \cdot {e ( g , g )}^{α s}}{{e ( g , g )}^{α s}} = key$$

is solved by the DU, the data ciphertext storage address ddr=Dec(key, CT_{addr}) is decrypted, the IPFS is accessed from addr to obtain data ciphertext CTₘ, and finally the data ciphertext is decrypted to obtain data plaintext m=Dec(key, CTₘ).

Therefore, the present disclosure provides the access control method based on outsourced computation and attribute-based searchable encryption on a blockchain, which addresses the limitations of existing attribute-based encryption, such as substantial local computational burden and low data-sharing efficiency, which can improve the efficiency and security of data sharing and reduce the computational burden on local users. Consequently, it effectively alleviates the computational burden of local encryption and decryption for users, and leads to a significant improvement in data sharing efficiency and security.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. An access control method based on outsourced computation and attribute-based searchable encryption on a blockchain, comprising the following steps:
S1, utilizing an attribute authority AA to initialize and generate a system public key PK and a master key MSK, and generating a user attribute private key SK based on an attribute set of a data user;
S2, formulating an access control policy by a data owner to assist an outsourced encryption service provider in performing a partial encryption, with the data user and the outsourced encryption service provider encrypting keywords, a data ciphertext storage address, and a symmetric key, and uploading the encrypted ciphertext to a blockchain for storage;
S3, generating a search trapdoor by the data user, sending the search trapdoor to the blockchain, calling a search trapdoor contract to verify the user attribute, and returning the relevant keyword-corresponding ciphertext to the DU if the user attributes satisfy the access control policy; and
S4, partially decrypting the ciphertext with assistance of an outsourced decryption service provider by the data user, followed by local decryption to obtain a data storage address and the symmetric key, downloading the data ciphertext from an InterPlanetary File System IPFS according to the storage address, and finally decrypting the data ciphertext utilizing the symmetric key to obtain data plaintext;
wherein in S1, the specific steps of utilizing the attribute authority to initialize and generate the system public key PK and the master key MSK are as follows:
utilizing the attribute authority to execute an initialization algorithm Setup(1^{λ})→(PK, MSK) and input a security parameter, thereby generating a multiplicative cyclic group G₁ and G_{T} of a prime order p, with a given bilinear mapping pair e: G₁× G₁→G_{T}, defining two random anti-collision Hash functions, wherein for each attribute i∈U, parameters t₁, t₂, and t₃ are randomly selected, and calculating e(g,g)^{α} and g^{β} respectively, thereby generating the system public key PK and the master key MSK:
$$PK = \{ {g}^{{t}_{1}} , {g}^{{t}_{2}} , {g}^{{t}_{3}} , {g}^{β} , {e ( g , g )}^{α} , {H}_{1} , {H}_{2} \} ;$$
$$MSK = \{ {t}_{1} , {t}_{2} , {t}_{3} , α , β \} ;$$
where e(g,g)^{α} and g^{β} are mathematical formulas of a double mapping pair in cryptography, and are all calculation results belonging to a component of the system public key PK, g is a generator of G₁, a mapping relationship
$${H}_{1} \text{:} {\{ 0 , 1 \}}^{*} \to {G}_{1} , {H}_{2} \text{:} {\{ 0 , 1 \}}^{*} \to {Z}_{p}^{*} , {Z}_{p}^{*}$$
denotes a finite field of 1, 2, . . . , p-1; {0,1}* denotes a set of bit strings of arbitrary length; U is a set of system attributes, and two integers α, and
$$β ∈ {Z}_{p}^{*}$$
of the finite field are randomly selected;
wherein in S1, the specific steps of utilizing the AA to generate the user attribute SK based on the attribute set of the data user are as follows:
S11, utilizing the attribute authority AA to execute a key generation algorithm KeyGenblind(PK,MSK,S)→(SK), inputting the system public key PK and the master key MSK and a user attribute set S, blinding each attribute i with the AA utilizing a Schnorr protocol, wherein i∈S, calculating Q and L, calculating a challenge σᵢ, and calculating a response of φⁱ to the challenge σᵢ, wherein calculation formulas are as follows:
$$Q = z \cdot G ;$$
$$L = m \cdot G ;$$
$${σ}_{i} = {H}_{2} ( G \vert Q \vert P \vert j ) ;$$
$${φ}_{i} = m + {σ}_{i} * z ( mod p ) ;$$
where Q denotes a blinded public key, L denotes a computational value of a binding of a signature and a message content, σᵢ denotes a randomly generated challenge sent by a verifier to a prover, σᵢ denotes a response generated by a prover based on a prover's secret and the challenge, and is sent to the verifier, G is a point on a elliptic curve, and the DU randomly selects two integers z,
$$m ∈ {Z}_{p}^{*}$$
in the finite field; and
S12, with info={P,Q, φᵢ, σᵢ}, sending info to an intelligent contract by the data user DU, wherein for each attribute i∈U, the attribute authority AA generates the attribute private key based on the blinded user attribute set, randomly selecting an integer
$$u ∈ {Z}_{p}^{*}$$
within the finite field, and calculating the attribute private key SK:
$$SK = \{ {D}_{1} = {g}^{\frac{( {t}_{1} {t}_{3} - u )}{{t}_{2}}} , {g}^{\frac{( α + u )}{β}} , {\{ {D}_{i} = {g}^{u} \cdot {{H}_{1} ( i )}^{{φ}_{i}} , {D}_{i}^{′} = {g}^{{φ}_{i}} \}}_{i ∈ S} ;$$
where info is a defined quadruple, and D₁ and D₂ are partial composition parameters of the attribute private key.

2. The access control method based on outsourced computation and attribute-based searchable encryption on a blockchain according to claim 1, wherein in S2, the specific steps of the DU and the outsourced encryption service provider encrypting the keywords, the data ciphertext storage address and the symmetric key, and uploading the encrypted ciphertext to the blockchain for storage are as follows:
S21, performing a partial encryption by the encryption service provider (ESP) to form an intermediate ciphertext; and
S22, on the basis of the intermediate ciphertext, performing a sequence by the DO of first encrypting the data plaintext, then encrypting the data ciphertext storage address, and finally encrypting a keyword set and the symmetric key.

3. The access control method based on outsourced computation and attribute-based searchable encryption on a blockchain according to claim 2, wherein in S21, the specific steps of performing the partial encryption by the ESP to form the intermediate ciphertext are as follows:
S211, executing an EncryptESP(PK,T) algorithm by the ESP, inputting the access control policy formulated by the user and converting it into an access structure tree T;
S212, utilizing the system PK starting from a root node of the access structure tree T, randomly selecting a polynomial qₓ of order dₓ for each non-leaf node x of the access structure tree from top to bottom, randomly selecting a positive integer
$$s ∈ {Z}_{p}^{*}$$
in the finite field as a node value of a root node R in the access structure tree T, setting qR(0)=s, and letting Y be an attribute set of the leaf nodes in access structure tree T; then calculating and outputting the intermediate ciphertext as:
$${CT}_{ESP} = \{ {D}_{x} , {D}_{x}^{′} \} , where {h}_{x} = {H}_{1} ( a t t ( x ) ) ; {D}_{x} = {g}^{{q}_{x} ( 0 )} ; {D}_{x}^{′} = {h}_{x}^{{q}_{x} ( 0 )} ;$$
where hx denotes a result of a Hash function H₁, an input att(x) is an attribute of the leaf node, Dₓ is a power term of a generator of the group G₁, D′ₓ is a power term result of the Hash function H₁, qₓ(0) is a value of the polynomial qₓ corresponding to the leaf node at 0 point, dₓ=kₓ−1, kₓ denotes a threshold of the node, and for other non-leaf nodes x, setting qₓ(0)=qparent(x)(index(x)), x∈γ.

4. The access control method based on outsourced computation and attribute-based searchable encryption on a blockchain according to claim 2, wherein in S22, the specific steps of performing the sequence by the DO of first encrypting the data plaintext, then encrypting the data ciphertext storage address, and finally encrypting the keyword set and the symmetric key are as follows:
S221, extracting a keyword set W in the data plaintext m by the DO, encrypting the data plaintext m by utilizing the symmetric key, generating a data ciphertext=Enc(m,key) and uploading it to the IPFS, and encrypting the returned data ciphertext storage address with the same symmetric key key to generate a storage address ciphertext CT_{addr}=Enc(addr,key);
S222, defining a keyword set W={ω} and the symmetric key by the DO, and performing an attribute-based encryption by executing an encryption algorithm Encrypt_{DO}(PK, CT_{ESP}, key, W)→CT, then randomly selecting a user attribute set
$$S ∈ {Z}_{p}^{*}$$
by the DO, calculating C₀=key·e(g,g)^{αs} and C₁=g^{βs}, and outputting the obtained symmetric key ciphertext as CT_{key}={C₀,C₁};
where C₀ and C₁ both denote symmetric key partial ciphertext, jointly forming the symmetric key ciphertext, C₀ is related to the symmetric key key, and C₁ is related to the attribute set S; and
S223, randomly selecting a positive integer field
$$n ∈ {Z}_{p}^{*} ,$$
calculating keyword ciphertext
$$C {T}_{ω} = \{ {C}_{2} = {g}^{{t}_{1} ( n + s )} \cdot {g}^{{t}_{2} n {H}_{2} ( ω )} , {C}_{3} = {g}^{{st}_{2}} \} ,$$
storage address ciphertext CT_{addr}=Enc(addr, key), and final ciphertext CT=(CT_{key}, CT_{ω}, CT_{addr}, CT_{ESP}), and uploading them to the blockchain for storage, wherein in the blockchain, an index generation contract is used to create an index for the keyword ciphertext, where C₂ and C₃ both denote partial ciphertexts of the keyword ciphertext.

5. The access control method based on outsourced computation and attribute-based searchable encryption on a blockchain according to claim 1, wherein in S3, the specific steps of the DU generates the search trapdoor and calls the intelligent contract in the blockchain to perform keyword matching and obtain the ciphertext are as follows:
S31, executing a Trapdoor generation algorithm Trapdoor(PK,SK,S,τ)→T_{τ} by the DU, inputting the system PK, the attribute SK, the attribute set S of the DU and a search keyword τ, randomly selecting an element
$$v ∈ {Z}_{p}^{*}$$
by the DU, calculating search trapdoor parameters
$${y}_{1} = {g}^{{t}_{1} v} \cdot {g}^{{t}_{2} v {H}_{2} ( τ )} , {y}_{2} = {g}^{{t}_{3} v} , {y}_{3} = {D}_{1}^{v} ,$$
generating a search trapdoor
$${T}_{τ} = \{ {y}_{1} , {y}_{2} , {y}_{3} , {\{ {B}_{i} = {( {D}_{i} )}^{v} , {B}_{i}^{′} = {( {D}_{i}^{′} )}^{v} \}}_{i ∈ S} \} ,$$
and sending it to the blockchain for a search verification;
S32, when calling the intelligent contract in the blockchain, firstly verifying a legality of the DU attribute, and when the verification is successful, searching the ciphertext corresponding to the matching keyword, wherein a calculation formula of the intelligent contract is L′=φᵢG−σᵢQ; and
S33, performing a determination, wherein: if L′=L, the attribute verification is successful, returning and sending the relevant ciphertext set to the DU, and the DU sends it to the outsourced decryption service provider, and if the attribute verification fails, terminating the entire algorithm process.

6. The access control method based on outsourced computation and attribute-based searchable encryption on a blockchain according to claim 5, wherein a search trapdoor intelligent contract in the blockchain is utilized to verify whether the DU attribute set satisfies the access control policy, and the attribute legitimacy is verified by a non-interactive Schnorr protocol.

7. The access control method based on outsourced computation and attribute-based searchable encryption on a blockchain according to claim 1, wherein in S4, the specific steps of partially decrypting the ciphertext with the assistance of the outsourced decryption service provider by the DU are as follows:
S411, returning a decryption result to the DU, adopting an execution algorithm Decrypt_{DSP}(PK, CT_{ESP}, T_{τ},S)→F_{Δ}, and dividing the process into two scenarios;
S4111, x(x∈S) is a leaf node, then a calculated value Fₓ of the leaf node x used for decryption is:
$${F}_{x} = \frac{e ( {B}_{i} , {D}_{x} )}{e ( {B}_{i}^{′} , {D}_{x}^{′} )} = {e ( g , g )}^{{uvq}_{x} ( 0 )} ;$$
where, when x∉S, Fₓ=∀;
S4112, x are non-leaf nodes, assuming that ρₓ is a set of child nodes with an arbitrary threshold, then for each child node w of the non-leaf nodes x, calculating a value F_{π} obtained from a weighted cumulative computation over each non-leaf node x within the set ρₓ used for decryption as:
$${F}_{π} = {\prod }_{π ∈ {ρ}_{x}} {F}_{π}^{{Δ}_{j , {ρ}_{x}^{′}} ( 0 )} {ρ}_{x}^{′} = \{ index ( π ) : π ∈ {ρ}_{x} \} ,$$
$$j = index ( π ) = {\prod }_{π ∈ {ρ}_{x}} {( {e ( g , g )}^{{uvq}_{π} ( 0 )} )}^{{Δ}_{j , {ρ}_{x}^{′}} ( 0 )} = {\prod }_{π ∈ {ρ}_{x}} {( {e ( g , g )}^{{uvq}_{x} ( j )} )}^{{Δ}_{j , {ρ}_{x}^{′}} ( 0 )} = {e ( g , g )}^{{uvq}_{x} ( 0 )} ;$$
S412, determining whether the attribute set of DU satisfies the access control policy, if the access control policy is satisfied, performing the partial decryption to obtain converted ciphertext F_{Δ}=e(g,g)^{uvs} and returning it to the DU.

8. The access control method based on outsourced computation and attribute-based searchable encryption on a blockchain according to claim 1, wherein in S4, the specific steps of obtaining the symmetric key after DU acquires the converted ciphertext and performs local decryption, followed by accessing IPFS to perform final decryption and obtain the plaintext data are as follows:
S421, utilizing an execution algorithm Decrypt_{DSP}(PK, CT, F_{Δ},SK,S)→m to decrypt the DU, calculating a result by the following formula:
$$θ = \frac{e ( {C}_{1} , {D}_{2} )}{{F}_{Δ}^{\frac{1}{v}}} = \frac{e ( {g}^{β s} , {g}^{\frac{( α + u )}{β}} )}{{e ( g , g )}^{us}} = {e ( g , g )}^{α s} ;$$
where θ denotes a partial decryption result of the symmetric key ciphertext, and the partial decryption result is used to decrypt the data ciphertext key; and
S422, solving the data ciphertext key
$$key = \frac{{c}_{0}}{θ} = \frac{key \cdot {e ( g , g )}^{α s}}{{e ( g , g )}^{α s}} = key$$
by the DU, decrypting the data ciphertext storage address ddr=Dec(key, CT_{addr}), accessing the IPFS from addr to obtain data ciphertext CTₘ, and finally decrypting the data ciphertext to obtain data plaintext m=Dec(key, CTₘ).
